(19) United States
(12) Patent Application Publication
(10) Pub. No.: US 2006/0285952 A1
(43) Pub. Date: Dec. 21, 2006

(54) Vehicle-mounted hoist with stabilizer assembly

(76) Inventors: Donald Galbreath, Winamac, IN (US); Randy Sommers, Kewanna, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/152,904

(22) Filed: Jun. 14, 2005

(51) Int. Cl. B62B 1/06

(52) U.S. Cl. 414/457

(57) ABSTRACT

A vehicle mounted hoist includes a vehicle having a main frame with a rear, an apron assembly connected to the rear of the main frame, a hoist frame pivotally connected at a hoist hinge to the apron assembly, and drive means for pivoting the hoist frame between a rest position and an inclined, loading position; and, a stabilizer assembly including a stabilizer having a distal end and being pivotally mounted to the apron assembly, the stabilizer assembly further including stabilizer pivot means connected between the stabilizer and the hoist frame for pivoting the stabilizer between a retracted position and an extended position, the extended position including the distal end of the stabilizer being at or near the ground.

### FIELD OF THE INVENTION

The present invention relates to a container hoist, and more particularly to an articulating stabilizer for a vehicle-mounted, tail-to-ground hoist.

### BACKGROUND OF THE INVENTION

Containers for transporting waste and bulk goods are typically transported by vehicle-mounted hoists. One type of such hoist includes a hoist frame that is pivotally mounted at a hinge to the rear of the truck main frame and that has a portion—the tail—that extends rearwardly of the hinge. In use, the hoist frame is tilted to an inclined, container loading position whereby the tail, being rearward of the hinge, pivots downwardly until it touches the ground proximal the front of the container to be picked up. A cable is payed out from the front end of the hoist frame and connected with the container and is then reeled in to pull the container onto the inclined hoist frame. At the initial stages of such loading when only a portion of the container is supported on the rear end of the inclined hoist frame, the combined center of gravity of hoist and loaded container is rearward of the rearmost axle (or suspension center in a tandem axle), and the front of the truck may tend to rise. Stabilizers connected with the truck main frame have been devised to shift the fulcrum rearwardly somewhat to prevent such front-end vehicle rise. Such stabilizers have a number of undesirable characteristics, such as obstructing or blocking trailer hitch access, being damaged if the truck is pulled forward while the stabilizer is in contact with the ground and simply not providing a significant shifting of the vehicle-container fulcrum. Improvements are continually being sought.

### SUMMARY

Generally speaking, a vehicle mounted, tail-to-ground hoist has an articulating stabilizer assembly mounted between the rear end of the vehicle main frame and the tail of the hoist frame, the stabilizer assembly having a stabilizer being pivotable from a retracted position to an extended position near or in contact with the ground in readiness to prevent the front of the hoist vehicle from lifting up while a container is being loaded onto the vehicle.

A vehicle mounted hoist includes a vehicle having a main frame with a rear, an apron assembly connected to the rear of the main frame, a hoist frame pivotally connected at a hoist hinge to the apron assembly, and drive means for pivoting the hoist frame between a rest position and an inclined, loading position; and, a stabilizer assembly including a stabilizer having a distal end and being pivotally mounted to the apron assembly, the stabilizer assembly further including stabilizer pivot means connected between the stabilizer and the hoist frame for pivoting the stabilizer between a retracted position and an extended position, the extended position including the distal end of the stabilizer being at or near the ground.

It is an object of the present invention to provide an improved vehicle-mounted hoist.

It is another object of the present invention to provide an improved stabilizer for a vehicle-mounted hoist.

Other object and advantages of the present invention will become apparent from the following description of the preferred embodiment.

### BRIEF DESCRIPTION OF THE DRAWINGS

FIG. 1 is a side, elevational view of a vehicle-mounted, tail-to-ground hoist 10 with a stabilizer assembly 11 in accordance with one embodiment of the present invention.

FIG. 2 is a side view of the rear of hoist 10 with stabilizer assembly 11 of FIG. 1, with hoist frame 13 in the hoist rest position 17 and stabilizer assembly 11 shown in the extended, hoist driving position 81.

FIG. 3 is a side view of the hoist 10 with stabilizer assembly 11 of FIG. 2, with hoist frame 13 in the hoist rest position 17 and stabilizer assembly 11 shown in the retracted position 75.

FIG. 4 is a rear, elevational view of the apron assembly 23 of the hoist 10 with stabilizer assembly 11 of FIG. 1.

FIG. 5 is a top view of the stabilizer 51 of stabilizer assembly 11 in FIG. 1.

FIG. 6 is a rear, elevational view of stabilizer 51 hingedly connected to the apron assembly 23 of hoist 10 with stabilizer assembly 11 of FIG. 1, and with stabilizer 51 shown rotated down against apron assembly 23.

FIG. 7 is a side view of the hoist 10 with stabilizer assembly 11 of FIG. 2, with hoist frame 13 in the inclined, container loading position 18 and stabilizer assembly 51 shown in the retracted position 75.

FIG. 8 is a side view of the hoist 10 with stabilizer assembly 11 of FIG. 2, with hoist frame 13 in the inclined, container loading position 18 and stabilizer assembly 51 shown extended and in contact with bumper/taillight assembly 27.

FIG. 9 is a side view of the hoist 10 with stabilizer assembly 11 of FIG. 2, with hoist frame 13 pivoted to a position between the horizontal rest position 17 and the container loading position 18 and with stabilizer 51 partially extended.

FIG. 10 is a side view of the hoist 10 with stabilizer assembly 11 of FIG. 2, with hoist frame 13 pivoted to a position between the horizontal rest position 17 and the container loading position 18 and with stabilizer 51 the fully extended position 76.

FIGS. 11-14 are side views of the entire hoist 10 with stabilizer assembly 11 of FIGS. 2, 3, 7 and 9, respectively FIG. 15 is a schematic showing a hydraulic circuit as would be appropriate for the present embodiment.

FIG. 16 is a schematic showing a hydraulic circuit 140 as would be appropriate for another embodiment of the present embodiment.

FIG. 15 is a schematic showing one hydraulic circuit as would be appropriate for another embodiment of the present embodiment.

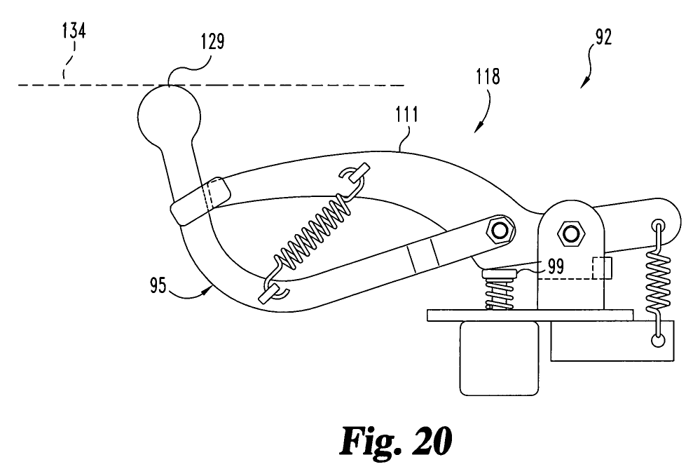

FIGS. 16 and 17 show hydraulic circuits 160 and 161 in accordance with alternative embodiments of the present invention.

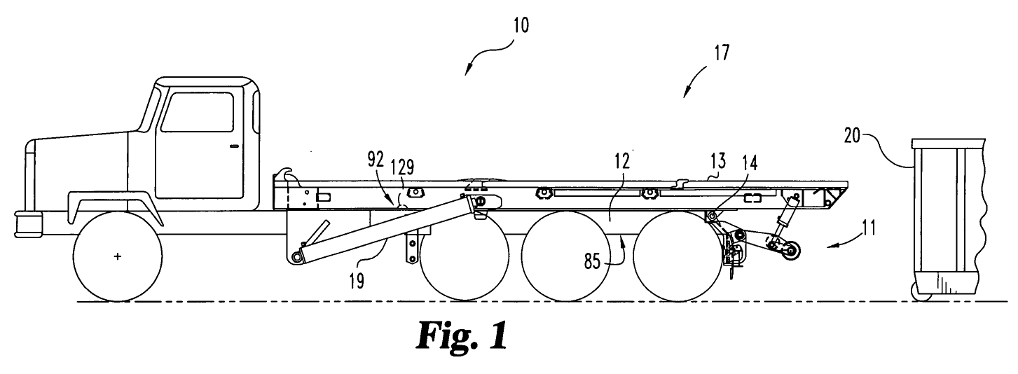

FIG. 18 is a side view of flow selector mechanism 92 connected to main frame 12 of the hoist of FIG. 1, and with flow selector mechanism 92 shown in the up position 120.

FIG. 19 is a top view of the flow selector mechanism 92 of FIG. 18.

FIG. 20 is a side view of the flow selector mechanism 92 of FIG. 18, and with flow selector mechanism 92 shown in the down position 118.

### DESCRIPTION OF THE SELECTED EMBODIMENT

For the purposes of promoting an understanding of the principles of the invention, reference will now be made to the embodiments illustrated herein and specific language will be used to describe the same. It will nevertheless be understood that no limitation of the scope of the invention is thereby intended. Any alterations and further modifications in the described processes, systems or devices, and any further applications of the principles of the invention as described herein, are contemplated as would normally occur to one skilled in the art to which the invention relates.

Referring to FIG. 1, there is shown a vehicle mounted, tail-to-ground hoist 10 with a stabilizer assembly 11 in accordance with the present invention. Hoist 10 is a truck that generally includes the stabilizer assembly 11, a vehicle main frame 12 and a hoist frame 13 that is hingedly connected at hinge pin 14 to pivot between a horizontal rest position 17 and an inclined, container-loading position 18 (FIG. 13). Hoist 10 further includes a pair of hoist cylinders (one shown at 19) for pivoting hoist frame 13 between the rest and inclined positions 17 and 18, respectively. Hoist 10 also includes various other cabling, cylinders, sheaves, etc. (not shown) to connect with and pull a container 20 up onto and to lower it down from hoist frame 13, as is known in the art.

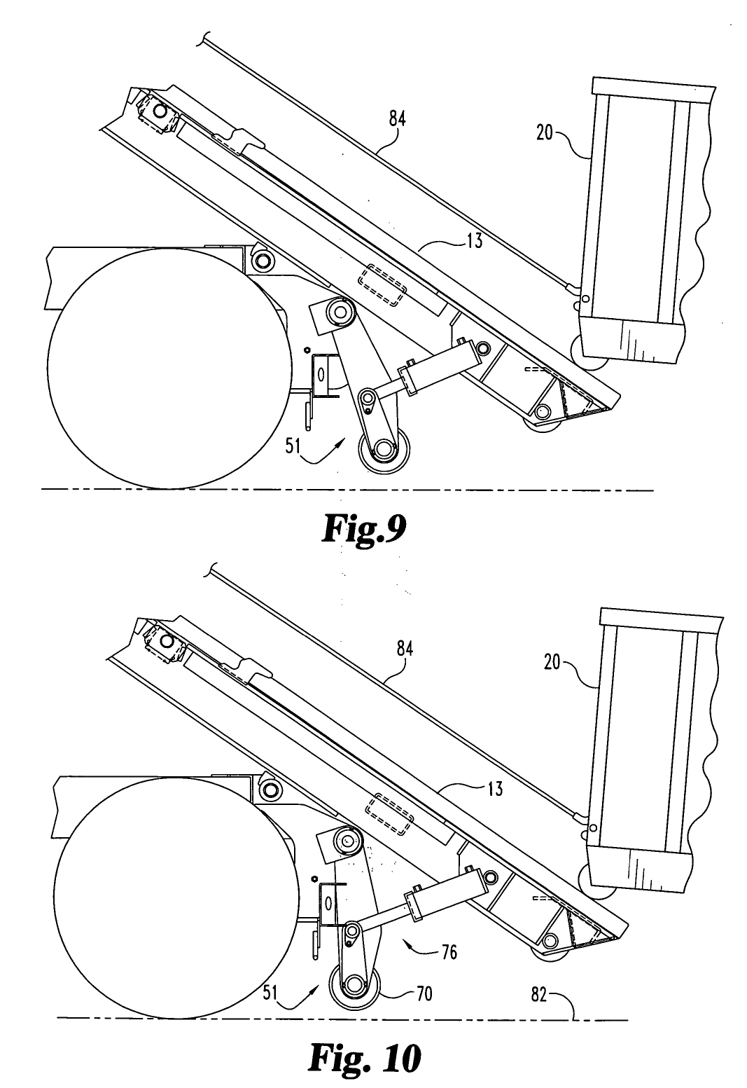

Referring to FIGS. 1-6, hoist 10 further includes an apron assembly 23 that is connected at the rear of main frame 12 and generally includes an apron plate 24, stabilizer mounting plates 25 and 26, bumper/taillight assembly 27, a hoist frame hinge assembly 28, a stabilizer hinge assembly 30, a pintle assembly 31, and a flow selector valve assembly 32. Apron plate 24 has numerous bends, is fixedly connected to the rear end of main frame 12 by appropriate means, such as welding, and extends downwardly therefrom to form a lower portion 33 on which are connected bumper/taillight assembly 27, pintle assembly 31 and stabilizer 51 of stabilizer assembly 11. Hoist frame hinge assembly 28 comprises four mounting tubes 35-38 that are held by four hinge plates 39-42, each of which is fixedly connected to the upper portion 34 of apron plate 24 by appropriate means, such as welding. Hoist frame 13 is thus hingedly connected via pins (one shown at 43) to pivot relative to main frame 12 between the rest position 17 and loading position 18.

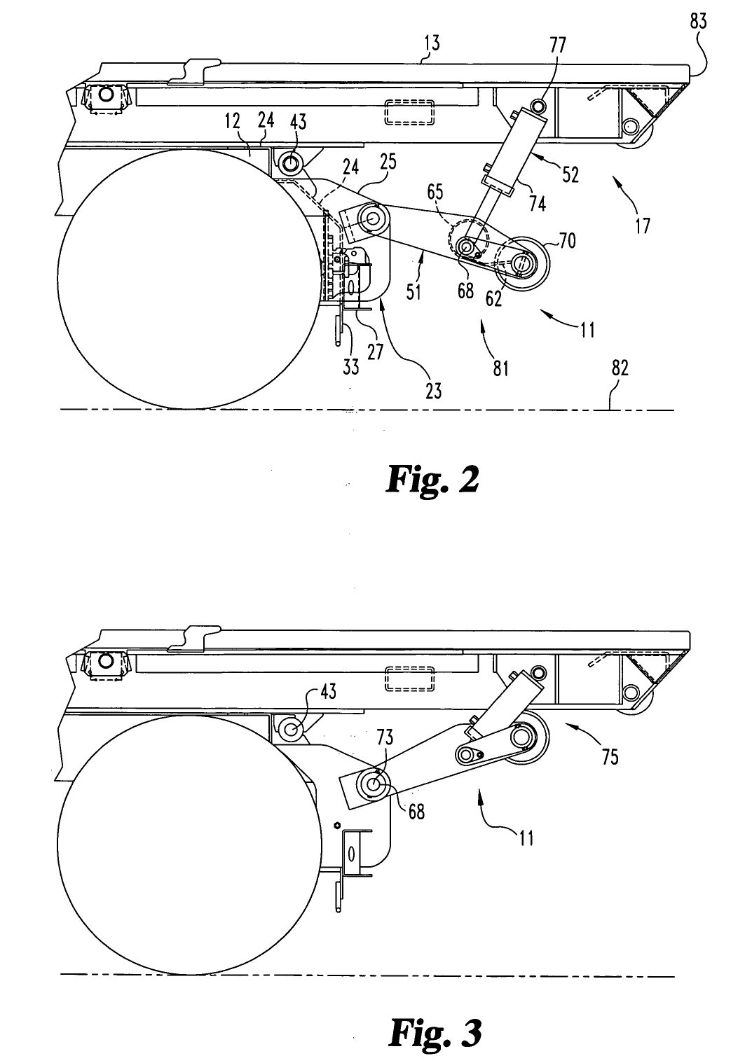

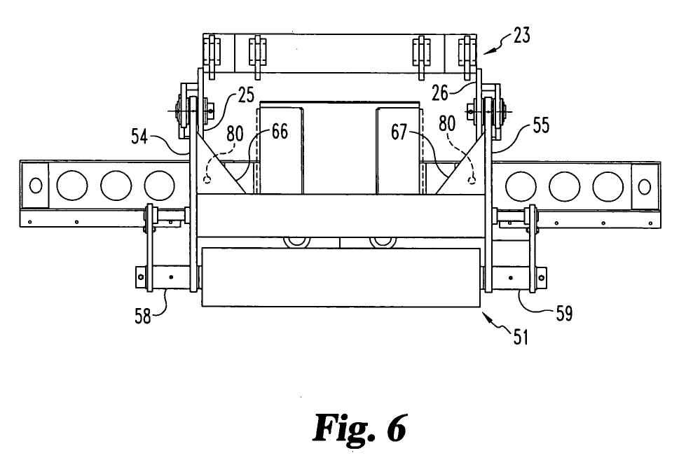

Opposing stabilizer mounting plates 25 and 26 extend at right angles from apron plate 24 on opposing sides of the hoist midplane 44, as shown in FIGS. 2 and 4. Stabilizer hinge assembly 30 includes four, coaxial pivot bearings 45-48 that are fixedly connected as by welding to the pair of stabilizer mounting plates 25 and 26, as shown. That is, one pair of pivot bearings 45 and 46 is mounted to the left side stabilizer mounting plate 25, with pivot bearing 46 held by stabilizer mounting plate 25, and the other pivot bearing 45 being held spaced therefrom by a left bracket arm 49a. The other pair of pivot bearings 47 and 48 is mounted to the right side stabilizer mounting plate 26, with pivot bearing 47 being held by right stabilizer mounting plate 26, and the other pivot bearing 48 being held spaced therefrom by bracket arm 49b.

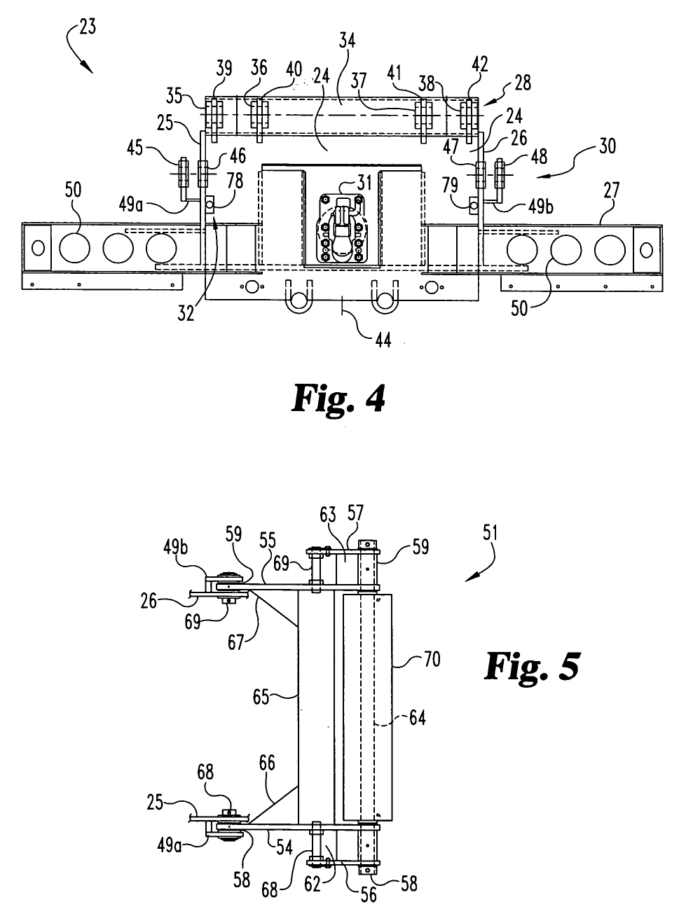

Pintle assembly 31 is provided to permit a trailer (not shown) to be connected thereto and pulled by hoist 10. Stabilizer assembly 11 is sized, configured and operable to move stabilizer 51 to the retracted position 75 (FIG. 3) to provide plenty of clearance to connect and pull a trailer at pintle assembly 31. Bumper/taillight assembly 27 carries a number of taillights 50 and extends laterally, outwardly of mounting plates 25 and 26.

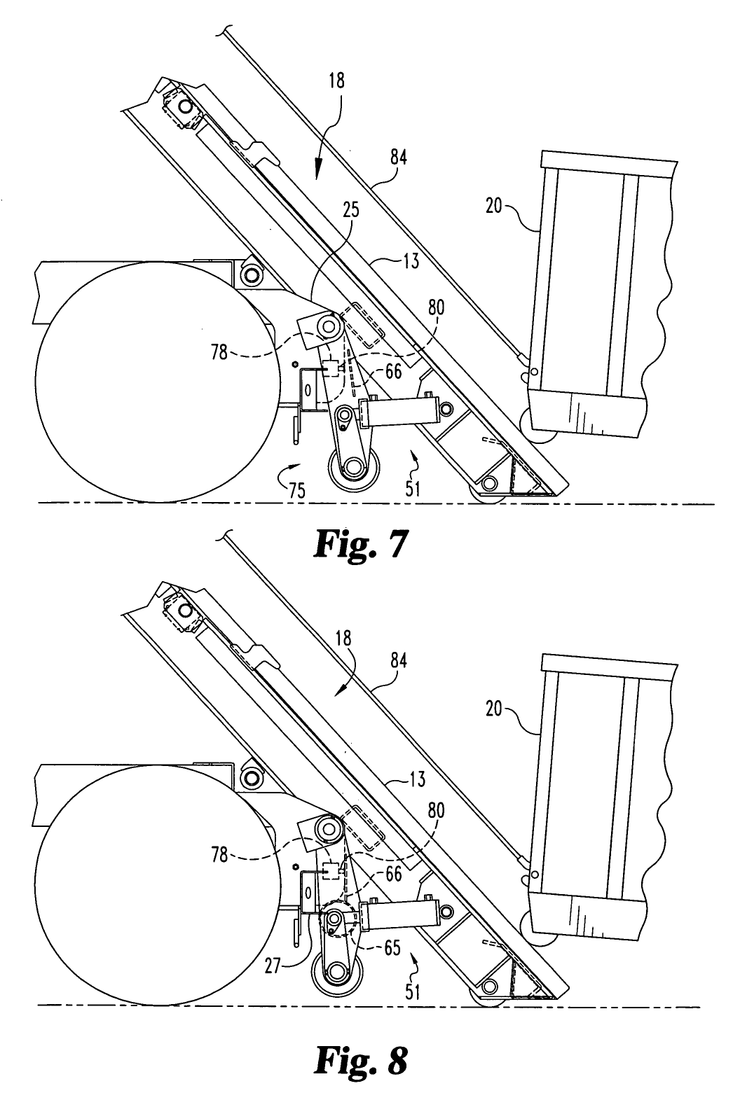

Stabilizer assembly 11 includes stabilizer 51 and a stabilizer cylinder assembly 52. Stabilizer 51 generally includes left and right roller arms 54 and 55 (FIG. 5), left and right outer cylinder supports 56 and 57, left and right arm bearings 58 and 59, left and right braces 62 and 63, roller shaft 64, support pipe 65, left and right gussets 66 and 67, left and right cylinder pins 68 and 69, and roller 70. Left and right roller arms 54 and 55 are fixedly connected in a space-apart relation by support pipe 65 and gussets 66 and 67, as shown, which are held together by appropriate means, such as welding. Outer cylinder supports 56 and 57 are connected with roller arms 54 and 55, respectively, in a spaced-apart relation, as shown, by left and right braces 62 and 63 and left and right arm bearings 58 and 59, which are held together by appropriate means, such as welding. Left and right cylinder pins 68 and 69 are held in mutually coaxial position, as shown, with pin 68 being held on the left by cylinder support 56 and roller arm 54, and cylinder pin 69 being held on the right by cylinder support 57 and roller arm 55. Roller 70 is held between roller arms 54 and 55 and for free rotation about roller shaft 64, which extends through and is held by arm bearings 58 and 59, which are held, respectively, by cylinder support 56 and roller arm 54 on the left and cylinder support 57 and roller arm 55 on the right. At their inboard ends, roller arms 54 and 55 are mounted for rotation to stabilizer hinge assembly 30 by pins 68 and 69 that extend through pivot bearings 44 and 46 on the left and 47 and 48 on the right. Stabilizer 51 is thus mounted for rotation about the axis 73 of pins 68 and 69 between the retracted (up) position 75 (FIG. 3) and the extended (down) position 81 (FIG. 2).

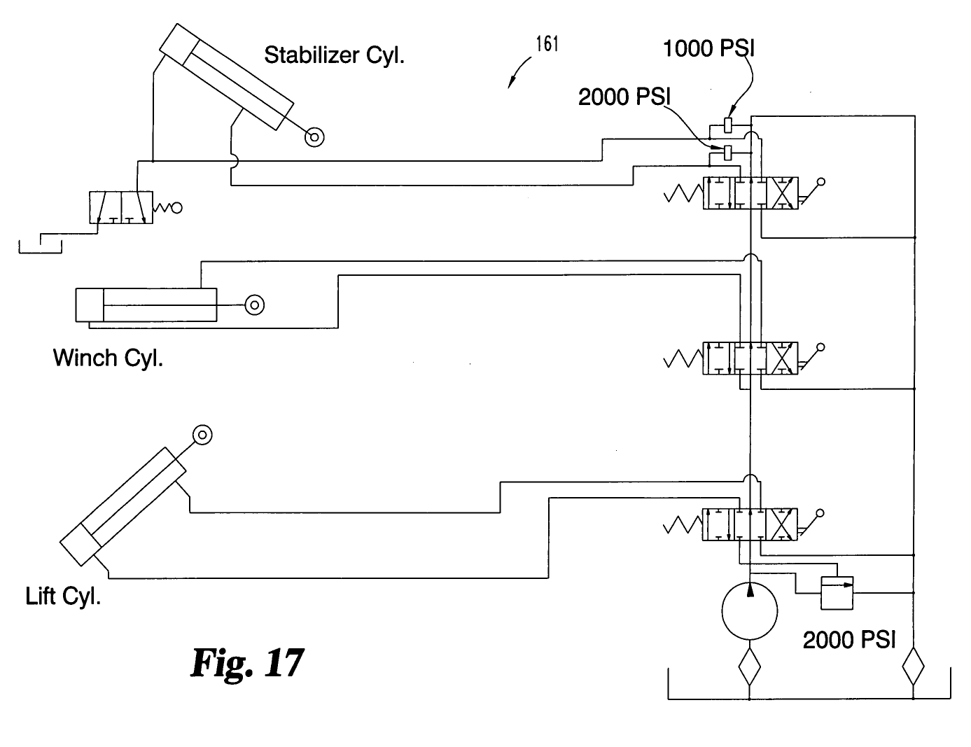

Stabilizer cylinder assembly 52 includes a pair of hydraulic cylinders (one shown at 74 in FIG. 2), the inboard end of each cylinder being mounted to hoist frame 13 at a respective one of opposing, coaxial hinge pins (one shown at 77 in FIG. 2), and the opposite, outboard end of each cylinder 74 being mounted to the respective one of the left and right cylinder pins 68 and 69 respectively. Complete retraction of the cylinders 74 pulls stabilizer 51 to its retracted position 75 (FIG. 2), and extension of the cylinders 74 pivots stabilizer 51 to its extended position 76 (FIG. 10) or 81 (FIG. 2).

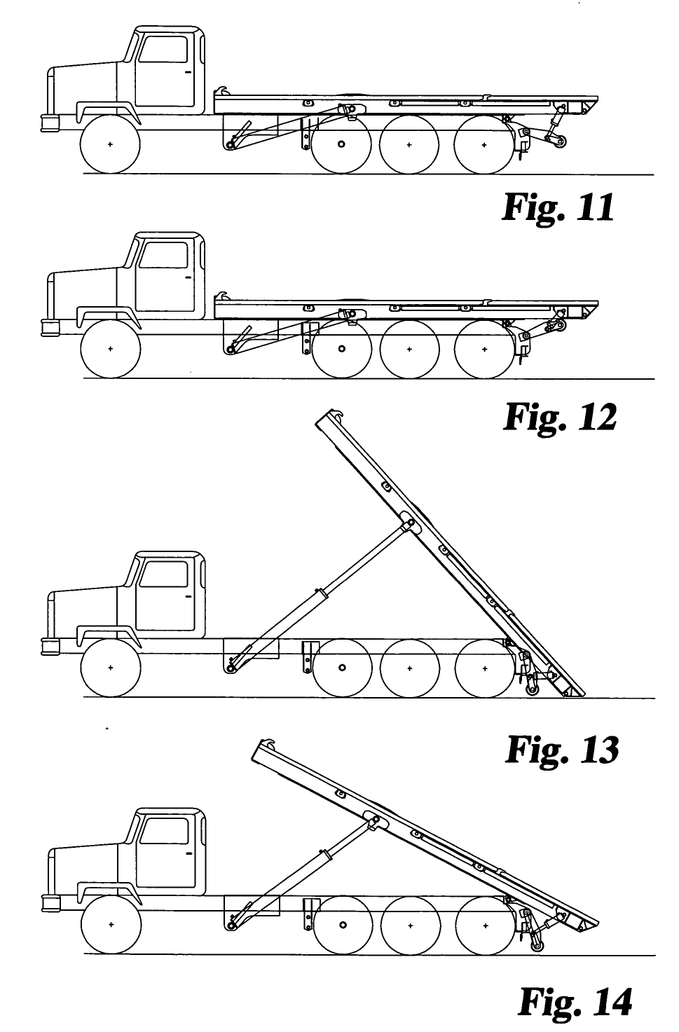

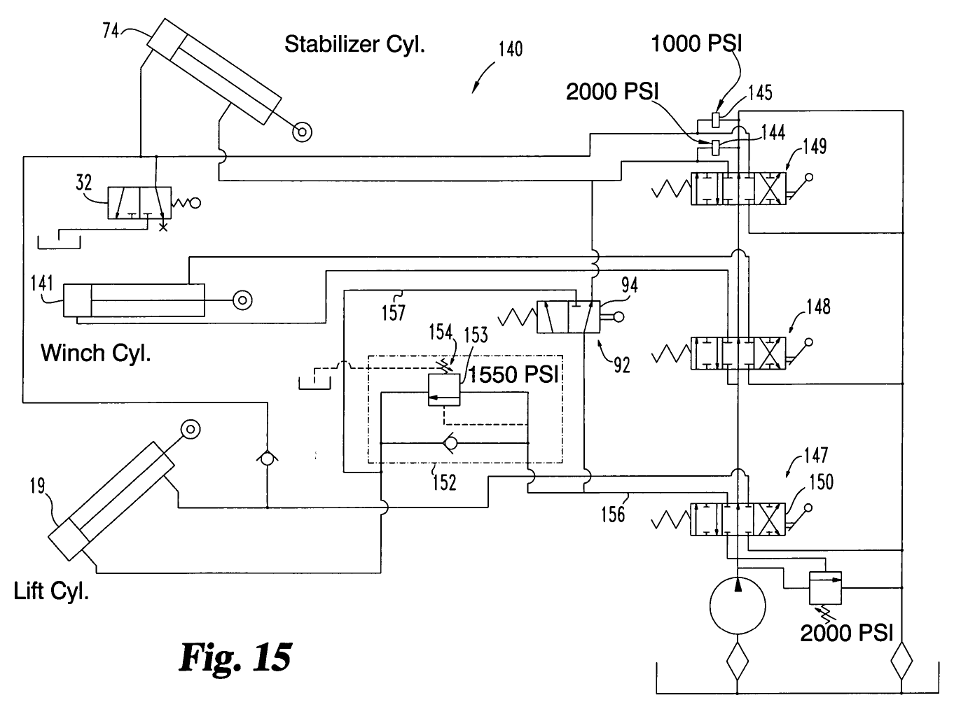

Flow selector valve assembly 32 includes two flow selector valves 78 and 79 mounted to the inside of the left and right side stabilizing mounting plates 25 and 26, each of which includes a select pin 80 that is spring biased to a rearwardly extending position. When stabilizer 51 is rotated about pins 68 and 69 toward contacting bumper/taillight assembly 27, bumper/taillight assembly 27 (as shown from FIG. 7 to FIG. 8), but before left and right gussets 66 and 67 will engage and depress the selector pins 80 of the two flow selector valves 78 and 79, whereby flow will be diverted from the pressure side 83 of stabilizer cylinders 74 to tank, and stabilizer 51 will no longer be forced to rotate clockwise (as viewed in FIG. 8) toward bumper/taillight assembly 27. This will prevent stabilizer 51 from damaging apron assembly 23 when hoist frame 13 is pivoted.

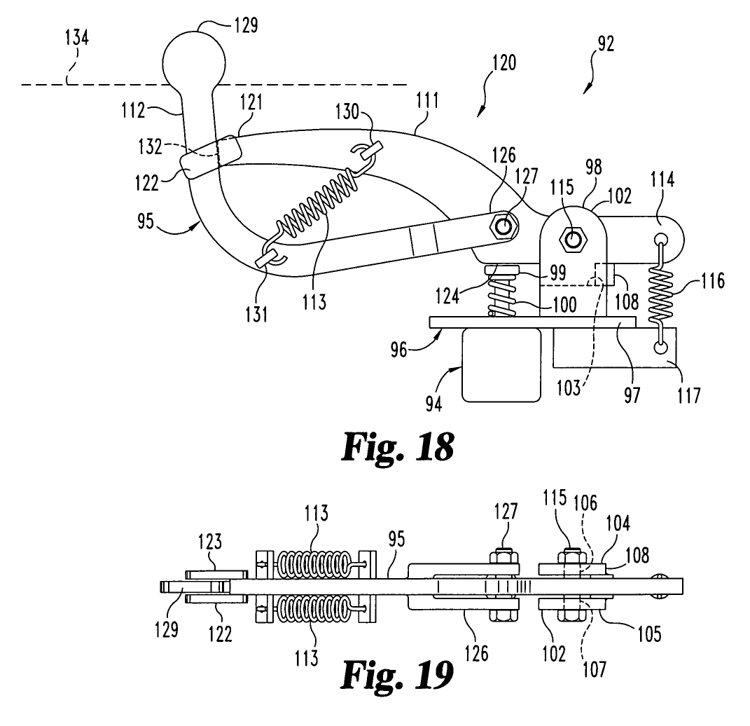

FIG. 2 represents hoist 10 in the transport position whereby hoist frame 13 is in the horizontal rest position 17 and stabilizer assembly 11 is in an extended, hoist driving position 81 (as shown in FIGS. 2 and 11). The size, shape and configuration of stabilizer assembly 11 when in the driving position 81 conforms to 49 C.F.R. 393.86 entitled “Rear end projection,” which is hereby incorporated by reference. In the embodiment shown in FIG. 2, with stabilizer assembly 11 in the extended, hoist-driving position 81, the axis of roller 70 is approximately 30 inches above ground 82 and is approximately 24 inches forward of the extreme rear 83 of vehicle-mounted hoist 10. In this embodiment, the overall width of roller 70 and left and right arm bearings 58 and 59 is approximately 60 inches with on overall container width of approximately 96 inches. Thus, the maximum transverse distance from the widest part of the vehicle at the rear to roller 70 and left and right arm bearings 58 and 59 does not exceed 18 inches. In addition, while stabilizer assembly can be articulated to the retracted position 75, when in extended hoist-driving position 81, stabilizer assembly 11 is substantially constructed and firmly attached. Thus, stabilizer assembly 11, in the extended, hoist-driving position 81 satisfies the bumper requirement for rear end protection under 49 C.F.R. 393.86.

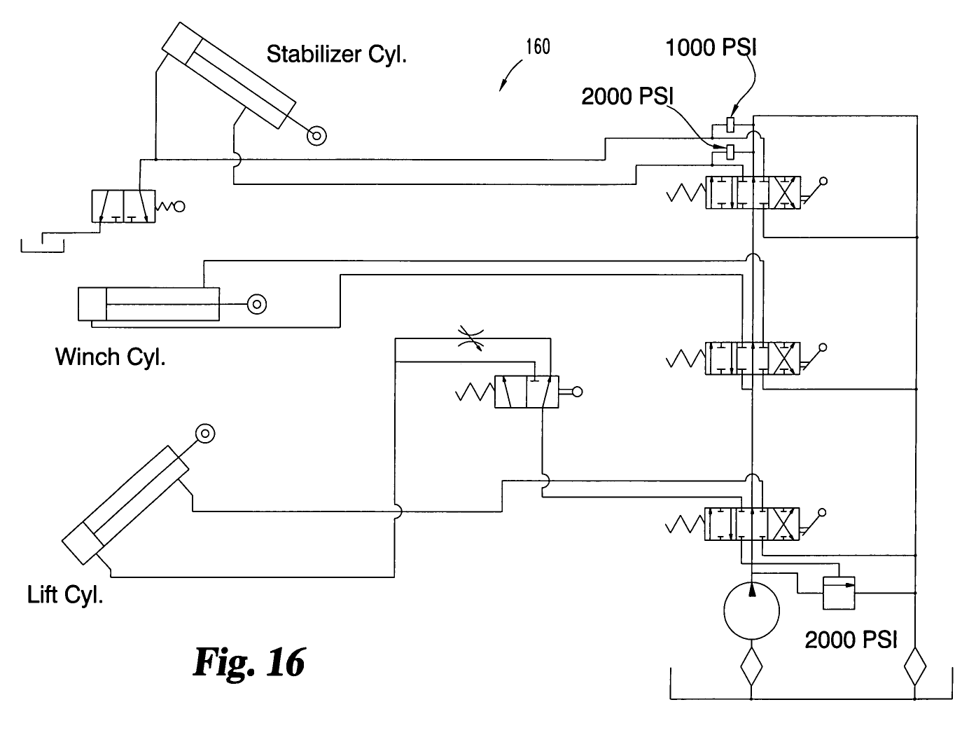

In operation, when it is desired to pick up a container 20, hoist 10 is parked with rear end 83 proximal to container 20, and stabilizer cylinders 74 are retracted, which rotates stabilizer 51 counterclockwise to an up position (as shown in FIGS. 3 and 12). Hoist frame 13 is then pivoted about pin 43 to the inclined, container-loading position 18 (FIGS. 7 and 13). Cylinders 74 are then actuated to pivot stabilizer 51 until left and right gussets 66 and 67 engage with select pins 80, which diverts flow from cylinders 74 and prevents further extension of cylinders 74 and further rotation of stabilizer 51. Stabilizer 51 is then in the nearly vertical position shown in FIG. 8. The appropriate cable 84 from hoist frame 13 is connected to the front of container 20 and is reeled in by a winch (cylinder or other device used to reel in the container-pulling container), which pulls container 20 up onto the rear of hoist frame 13 (as shown in FIG. 7). Ultimately, container 20 is pulled all the way up onto hoist frame 13, and hoist frame 13 is pivoted to its horizontal rest position 17. After container 20 is properly secured to hoist frame 13, the vehicle hoist 10 is now in a condition to transport container 20. In practice, the winch (or other mechanism for pulling the container) may not have sufficient power to initially pull a fully loaded container all the way up the steeply inclined hoist frame 13. Often, such container 20 may only be able to be pulled a short distance up hoist frame 13. The operator will then activate cylinders 19 to pivot hoist frame 13 downward several degrees to an intermediate position (for example, as shown in FIGS. 9 and 14) to reduce the slope and enable container 20 to be pulled farther up onto hoist frame 13. The operator may proceed through several iterations of pulling container 20 and lowering hoist frame 13. At one or more of such stages of pulling container 20 onto hoist frame 13, the combined center of gravity of hoist 10 and the end of a loaded container 20 resting on hoist frame 13 may be rearwardly of the fulcrum of such combination, which may be at the common suspension mount (indicated generally at 85 in FIG. 1), which may cause the front end of the hoist vehicle to rise. To the extent permitted by the extension limit of cylinders 74 (and possibly by selector valve assembly 32), stabilizer 51 is rotated downwardly to its fullest extent (for example, as shown in FIG. 10) after hoist frame 13 is rotated to the position in FIG. 9. In practice, the weight of hoist 10 and the container 20 partially resting on hoist frame 13 will compress the suspension somewhat, and the roller 70 of stabilizer 51 will be closer if not in contact with ground 82. Such contact becomes the new rearward-most fulcrum point for hoist 10, which will likely now be rearward of the combined center of gravity, and the front end of hoist 10 will be prevented from rising up or will not be able to rise up very much. The extended position (76 or 81) of stabilizer 51 contemplates the roller 70 at the distal end of stabilizer 51 being at or near the ground in readiness to prevent hoist 10 from rocking rearwardly.

Once hoist frame 13 is fully rotated to its horizontal rest position and container 20 is secured in place, stabilizer 51 is rotated via cylinders 74 to the desired extended, hoist driving position 81.

Referring to FIGS. 18-19, hoist 10 further includes a flow selector mechanism 92 connected to main frame 12 (FIG. 1) and including a flow selector valve 94, a lever assembly 95 and a base 96. Base 96 includes a base plate 97 and a lever mount 98 extending upwardly therefrom. Flow selector valve 94 is mounted to base plate 97 and includes a selector pin 99 extending upwardly from base 97 and to the side of lever mount 98. Flow selector valve 94 has two positions: a rest position whereby selector pin 99 is spring biased up (as shown) by a spring 100 and a down position, forced thereto by lever assembly 95. Lever mount 98 includes a clevis 102 that defines a valley 103 and has a pair of opposing arms 104 and 105, which define coaxial holes 106 and 107. Stop 108 is mounted to valley 107, between arms 104 and 105 and offset to the right (as viewed) from holes 106 and 107.

Anchor lever 111 is pivotally mounted near its inboard end 114 to lever mount 98 by a pin 115 that extends through holes 105 and 106. A spring 116 extends in tension between an arm 117 of base plate 97 and the inboard end 114 of anchor lever 111 to bias anchor lever 111 clockwise, as viewed in FIG. 18. Anchor lever 111 is limited to rotate between an up position 120 (as shown in FIG. 18) and a down position 118. The up position is defined as anchor lever 111, biased clockwise by spring 116, contacts stop 108 of lever mount 98. The down position is defined by hoist frame 13 resting on main frame 12 and depressing contact lever 112.

At its outboard end 121 anchor lever 111 is forked, defining arms 122 and 123, which slidably straddle hoist frame contact lever 112. Between its mounting at pin 115 and its outboard end 121, anchor level 111 defines a pin contact surface 124 that is positioned above and is configured for engaging with and depressing pin 99 of flow selector valve 94.

Hoist frame contact lever 112 is generally L-shaped and is pivotally mounted at one end 126 to anchor lever 111 by a pin 127. End 126 is mounted to anchor lever 111 generally above pin contact surface 124, but such mounting on lever 111 may vary to provide the desired response characteristic of flow selector mechanism 92. At its opposite, upper end, contact lever 112 defines a hoist frame contact surface 129. Springs 113 are mounted to extend from spring mounts 130 of anchor lever 111 and spring mounts 131 of contact lever 112, as shown. Spring mounts 130 are located along anchor lever 111 roughly between its outboard and 121 and its pivot mount at 115. Spring mounts 131 are located on lever 112 roughly midway between its hoist contact end 129 and its pivot mount at 127 to anchor lever 111. Springs 113 bias anchor lever 112 to a rest position pivotally mounted at 127 to anchor lever 111 and in contact near its distal end with the outer-most end 132 of anchor lever 111. In the rest position shown in FIG. 18, flow selector mechanism 92 is set so that hoist contact surface 129 is approximately two inches above the upper surface 134 of main frame 12, and there is a slight gap (approximately 0.5 mm to 1.5 mm) between the top of pin 99 and pin contact surface 124. Thus, as hoist vehicle 10 is being driven over rough surfaces, the vibration will cause little or no abrasive contact between pin 99 and surface 124. The height of pin 99 in flow selector valve 94 is adjustable, as known, above base plate 97, which allows the gap between pin 99 and surface 124 to be set, as desired. Alternative embodiments are contemplated wherein stop 108 may be made as an adjustable element using a threaded pin or other structure to vary the distance that hoist frame contact surface 129 extends above upper surface 134 of main frame 12. Such adjustability may be desired to vary the moment of activation of flow selector mechanism 92 during operation of the hoist mechanism.

In operation, when hoist frame 13 is in the inclined, container-loading position 18 and is lowered to the hoist rest position 17, when hoist frame 13 contacts hoist frame contact surface 129 (roughly two inches above main frame 12), further lowering of hoist frame 13 will depress contact lever 12 downwardly, which will rotate about pin 127 against the bias of springs 113. As contact lever 112 continues to be depressed and the pulling force of spring 113 increases, anchor lever 111 will begin to rotate against the bias of spring 116, whereby pin contact surface 124 will contact pin 99 and depress pin 99, which action will switch flow selector valve 94 from its through position to its blocked position, which in turn will block fluid flow through valve 94 to lift cylinders 19 and reduce the rate of pivoting of hoist frame 13. Thus, as hoist frame 13 engages contact lever 112 and switches the position of flow selector valve 94, the rate of descent of hoist frame 13 is reduced, thereby allowing a softer landing of hoist frame 13 against main frame 12. Likewise, when hoist frame 13 is in the rest position 17 against main frame 12, and hoist frame control 147 (FIG. 15) is activated to raise hoist frame 13 (valve block 150 of control 147 moves to the right as seen in FIG. 15), and once stabilizers 51 have pivoted up, as described below, contact lever 112 will be down and the flow rate to hoist lift cylinders 19 will be limited to flow through sequence valve 152, and the rate of ascent of hoist frame 13 will be slow. Once hoist frame 13 rises about two inches—at the positionment of hoist frame contact lever 112—flow selector valve 94 will be switched to the through position (the valve block at 92 will move to the right as seen in FIG. 15), and the flow rate to lift cylinders 19 will increase, thereby increasing the rate of ascent of hoist frame 13. In the present embodiment, flow selector mechanism 92 is mounted to main frame 12 a distance forwardly of hinge 14, whereby hoist frame contact surface 129 is approximately two inches above the top surface 134 of main frame 12. Flow selector mechanism 92 may be positioned at an alternative location along main frame 12, which would cause hoist frame 13 to be at a different angle relative to main frame 12 when it contacts hoist frame contact surface 129.

Referring to FIG. 15, there is shown a hydraulic circuit 140 suitable for use with stabilizer assembly 11 and the other hydraulic components of hoist 10. The components to which hydraulic circuit 140 is connected are labeled with like reference numbers. The hydraulic circuit 140 is connected to drive and control the lift cylinders 19, stabilizer cylinders 74, and winch cylinders (not shown but indicated at 141 of hydraulic circuit 140). Hydraulic circuit 90 further includes anti-cavitation valve 144 and port relief valve 145 that are set at 2,000 psi and 1,000 psi respectively. The control units for lift cylinders 19, winch cylinders 141 and stabilizer cylinders 74 are indicated at 147, 148, and 149 respectively. The maximum flow rate through sequence valve 152 is 30 gallons per minute. When control mechanism 147 is initially activated to raise hoist frame 13 from the down position 17, all fluid flow will be directed through the flow selector valve 92 to the stabilizer cylinders 74, and because less than 1550 psi will be seen by the sequence valve 152, no flow will be permitted through sequence valve 152, and therefore lift cylinders 19 will not activate. Once the stabilizer cylinders 74 are completely retracted and deadhead, sequence valve 152 will see in excess of 1550 psi, will open, and flow will be directed therethrough to lift cylinders 19. The valve member 153 of sequence valve 152 has an adjustable pressure spring 154 that permits the threshold value of sequence valve 152 to be varied. In the present embodiment, sequence valve 152 is set at 1550 psi. It is noted that flow selector mechanism 92 is shown in FIG. 15 in the down, through position. With the hydraulic circuit 140, hoist 10 will initially operate as follows: to raise lift cylinders 19, lift cylinder control 147 is activated, whereby the valve block of cylinder control 147 moves to the right as shown in FIG. 15 to permit flow through line 156 to sequence valve 152 and flow selector mechanism 92. With flow selector valve 94 in the down position, flow is permitted to flow therethrough and directly to stabilizer cylinders 74, whereby cylinders 74 retract to pivot stabilizer assembly 11 to the retracted position 75. At this time, no flow is permitted to lift cylinders 19. Once stabilizer cylinders 74 are completely retracted, sequence valve 152 will see a pressure in excess of 1550 psi from line 156, and valve 153 will shift to an open position, thereby directing flow to lift cylinders 19, and hoist frame 13 will begin to rise. The maximum flow rate through sequence valve 152 is approximately 30 gallons per minute in the present embodiment. Once hoist frame 13 rises enough to permit flow selector mechanism 92 to move flow selector valve 94 to the up position, fluid will flow through both sequence valve 152 and flow selector mechanism 92, the increased flow rate causing lift cylinders 19 to extend at a greater rate and hoist frame 13 to rise at a greater rate. The present embodiment, including the hydraulic circuit of FIG. 15, thus operates to raise hoist frame 13 from the rest position 17 upon activating control 147 by first automatically pivoting stabilizer assembly 11 to the retracted position 75 (unless stabilizer assembly 11 has already been moved to the retracted position by operating the stabilizer control 149) and then automatically raising hoist frame 13.

FIGS. 16 and 17 show hydraulic circuits 160 and 161 in accordance with alternative embodiments of the present invention.

The present embodiment incorporates apron assembly 23 to which are mounted hoist frame 13 stabilizer 51 and other of the hoist components. The invention contemplates other structure and/or configurations for connecting hoist frame 13 and stabilizer 51. For example, and without limitation, either or both of hoist frame 13 and stabilizer 51 can be mounted directly to main frame 12, and recitation of such hoist frame 13 and/or stabilizer 51 being connected to apron assembly 23 contemplates such structures being connected in accordance with such other configurations, including being connected directly to main frame 12.

The present embodiment has been described for use in providing stabilization to hoist 10 during the loading of a container (whether empty or partially or fully loaded). More generally, stabilizer assembly 11 is contemplated to provide stabilization during manipulation of a container with hoist frame 13 at any inclined position, which includes loading, unloading and/or dumping a container.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed:

1. A vehicle mounted hoist with a stabilizer for providing a rearward, ground-engaging fulcrum, comprising:
a vehicle having a main frame with a rear, an apron assembly connected to the rear of the main frame, a hoist frame pivotally connected at a hoist hinge to the apron assembly, and drive means for pivoting the hoist frame between a rest position and an inclined, loading position;
a stabilizer assembly including a stabilizer having a distal end and being pivotally mounted to the apron assembly, the stabilizer assembly further including stabilizer pivot means connected between the stabilizer and the hoist frame for pivoting the stabilizer between a retracted position and an extended position, the extended position including the distal end of the stabilizer being at or near the ground.

2. The vehicle mounted hoist of claim 1 wherein the hoist frame has a tail extending rearwardly of the hoist hinge.

3. The vehicle mounted hoist of claim 2 wherein the stabilizer pivot means is connected at one end to the tail and connected at an opposite end to the stabilizer.

4. The vehicle mounted hoist of claim 2 wherein the stabilizer pivot means includes at least one hydraulic cylinder connected at one end to the tail and connected at an opposite end to the stabilizer.

5. The vehicle mounted hoist of claim 2 wherein the stabilizer has a proximal end pivotally connected to the apron assembly and includes a roller connected at an opposing distal end.

6. The vehicle mounted hoist of claim 5 wherein the stabilizer pivot means is connected at one end to the tail and connected at an opposite end to the stabilizer between distal and proximal ends of the stabilizer.

7. The vehicle mounted hoist of claim 1 wherein the stabilizer pivot means the drive means are part of a common interconnected hydraulic circuit.
